(19) United States
(12) Patent Application Publication
(10) Pub. No.: US 2022/0174254 A1
(43) Pub. Date: Jun. 2, 2022

(54) A CAMERA ASSEMBLY AND A METHOD

(71) Applicant: JAGUAR LAND ROVER LIMITED, Whitley, Coventry, Warwickshire (GB)

(72) Inventor: Andrew LEWIN, Harbury, Warwickshire (GB)

(21) Appl. No.: 17/436,045

(22) PCT Filed: Feb. 28, 2020
(86) PCT No.: PCT/EP2020/055244

§ 371 Date: Sep. 2, 2021

(30) Foreign Application Priority Data
Mar. 2, 2019 (GB) 1902846.3

(51) Int. Cl. H04N 13/239; B60R 11/04; H04N 5/225; G06V 20/58; H04N 5/232; G03B 30/00

(52) U.S. Cl. CPC H04N 13/239; B60R 11/04; H04N 5/2254; B60R 2011/0026; H04N 5/23296; G03B 30/00; G06V 20/582

(57) ABSTRACT

Aspects of the present invention relate to a camera assembly for a vehicle, a system for a vehicle, a vehicle and a method. The camera assembly includes an image sensing device comprising a sensing surface having a width, a height and a centre line extending laterally across the width, the image sensing device being configured to generate image data indicative of an image received at the sensing surface. The camera assembly also comprises a lens positioned to produce an image on the sensing surface. The lens has an optical axis that is offset from the centre line of the sensing surface.

### TECHNICAL FIELD

The present disclosure relates to a camera assembly, a system, a vehicle and a method. In particular, but not exclusively it relates to a camera assembly for a vehicle such as a car, a system for a vehicle, a vehicle and a method.

### BACKGROUND

Recently produced forward looking cameras (FLCs), which are used for active safety and/or cruise features on cars, use a standard camera chip module with specially designed lenses to simulate the foveal patch of a human eye. In the human eye the lens is “normal” and the light sensors in the retina are more closely packed in the area which views the straight ahead direction. To simulate this in a forward looking camera, the lens is designed to provide a distortion to cause the image projected onto a central portion of the camera chip, in the vicinity of the optical axis of the lens, to become stretched compared to outer portions of the image that are nearer to the edges of the camera chip. I.e., to provide the high resolution of the straight ahead view at the centre of the camera chip, the lens distortion causes the outer pixels of the camera chip to cover a wider angular range of the scene being imaged.

Although such lenses provide the camera with a wide angle field of view, the field of view in the vertical direction is still not wide enough in some scenarios, to image objects, such as road signs, that are positioned above the height of the camera.

It is an aim of the present invention to address one or more of the disadvantages associated with the prior art.

### SUMMARY OF THE INVENTION

Aspects and embodiments of the invention provide a camera assembly for a vehicle, a system for a vehicle, a vehicle, a method of assembling components of a camera for a vehicle as claimed in the appended claims.

According to an aspect of the invention there is provided a camera assembly for a vehicle, the camera assembly comprising: an image sensing device comprising a sensing surface having a width, a height and a centre line extending laterally across the width, the image sensing device being configured to generate image data indicative of an image received at the sensing surface; and a lens having an optical axis, and positioned to produce an image on the sensing surface; wherein the optical axis of the lens is offset from the centre line of the sensing surface.

This provides the advantage that, when the camera assembly is oriented so that the optical axis is substantially horizontal, a major portion of the field of view of the camera assembly may be arranged to be above the optical axis of the lens. This allows objects of interest that are at steeper angles up from the camera assembly to be imaged during use. However, for a lens that provides its greatest resolution in the vicinity of the optical axis, a portion of a scene that is horizontally ahead of the camera assembly may be imaged with greatest resolution, and therefore objects that are positioned on, or close to, the optical axis of the camera assembly may be identified at the greatest distances achievable by the camera assembly.

Optionally, the lens is configured to provide image magnification that decreases with distance from the optical axis. This provides the advantage that it enables objects positioned on, or close to, the optical axis of the lens to be identified using the camera assembly at larger distances than might otherwise be possible.

Optionally, the image sensing device comprises a two-dimensional array of sensing elements; at the optical axis, the lens is configured to project 1 degree of the view from the lens over a first number of the sensing elements; the lens is configured to project 1 degree of the view from the lens over a second number of the sensing elements adjacent to an edge of the sensing surface; and the first number is at least 1.5 times the second number. This provides the advantage that it enables objects positioned on, or close to, the optical axis of the lens to be identified using the camera assembly at larger distances than might otherwise be possible, while enabling the camera assembly to provide image data representing a wide field of view.

Optionally, the optical axis of the lens is offset from the centre line of the sensing surface by a distance of more than one tenth of the height of the sensing surface.

Optionally, the camera assembly comprises a printed circuit board on which the image sensing device and the lens are mounted. This provides the advantage that it is easy to repeatedly achieve the required alignment of lenses to image sensing devices.

Optionally, the sensing surface is arranged in a vertical plane and the optical axis of the lens is vertically offset from the centre line of the sensing surface. This provides the advantage that the field of view imaged by the image sensing device is vertically offset, but the portion of the image corresponding to a straight ahead view has the highest resolution.

Optionally, the sensing surface defines a vertical field of view of the camera assembly that extends between an upper direction and a lower direction, wherein a first angle between the upper direction and the optical axis of the lens is larger than a second angle between the lower direction and the optical axis. This provides the advantage that objects at positions above the height of the camera may be imaged at larger angles to the optical axis than they otherwise would be.

Optionally, the camera assembly and a similarly configured camera assembly form parts of a stereoscopic camera.

According to another aspect of the invention there is provided a system for a vehicle comprising the camera assembly according to any one of the previous paragraphs and a processing means configured to process the image data to detect vehicles and/or road signs in the field of view of the camera assembly.

Optionally, the processing means is configured to process the image data to provide corrected image data in dependence on radial distortion produced by the lens and in dependence on said offset.

According to a further aspect of the invention there is provided a vehicle comprising a camera assembly according to any one of the previous paragraphs or a system according to one of the previous paragraphs.

Optionally, the vehicle has a windscreen and a bonnet positioned in front of the windscreen; the lens is positioned to project an image onto the sensing surface of a view out through the windscreen; and the offset enables at least 90% of the image to be free from an image of the bonnet. This provides the advantage that only a small portion of the image is wasted by imaging the bonnet.

Optionally, the offset prevents a representation of the bonnet from appearing within the image. This provides the advantage that none of the image is wasted by imaging the bonnet.

According to yet another aspect of the invention there is provided a method of assembling components of a camera for a vehicle, the method comprising: fixing an image sensing device to a supporting structure, the image sensing device having a width, a height and a centre line extending laterally across the width, and the image sensing device being configured to generate image data indicative of an image received at the sensing surface; and fixing a lens in position relative to the image sensing device to enable the lens to produce an image on the sensing surface; wherein the lens is fixed in position with an optical axis of the lens offset from the centre line of the sensing surface.

This provides the advantage that, when the camera assembly is oriented so that the optical axis is substantially horizontal, a major portion of the field of view of the camera assembly may be arranged to be above the optical axis of the lens. This allows objects of interest that are at steeper angles up from the camera assembly to be imaged during use. However, for a lens that provides its greatest resolution in the vicinity of the optical axis, a portion of a scene that is horizontally ahead of the camera assembly may be imaged with greatest resolution, and therefore objects that are positioned on, or close to, the optical axis of the camera assembly may be identified at the greatest distances achievable by the camera assembly.

Optionally, the lens is selected to provide image magnification that decreases with distance from the optical axis.

Optionally, the image sensing device comprises a two-dimensional array of sensing elements; the lens is fixed at a position in which 1 degree of the view from the lens is projected over a first number of the sensing elements adjacent to the optical axis, and 1 degree of the view from the lens is projected over a second number of sensing elements adjacent to an edge of the sensing surface; and the first number is at least 1.5 times the second number.

Optionally, the method comprises fixing the lens in position with the optical axis of the lens offset from the centre line of the sensing surface by a distance of more than one tenth of the height of the sensing surface.

Optionally, the method comprises mounting the image sensing device and the lens on a printed circuit board.

Optionally, the method comprises positioning the sensing surface in a vertical plane with the optical axis of the lens vertically offset from the centre line of the sensing surface.

Optionally, said positioning the sensing surface comprises arranging a vertical field of view of the camera to extend between an upper direction and a lower direction, so that a first angle between the upper direction and the optical axis of the lens is larger than a second angle between the lower direction and the optical axis.

Optionally, the method comprises fixing both a first image sensing device and a first lens, and a second image sensing device and a second lens in position in accordance with any one of claims 13 to 19 to form a stereoscopic camera.

Optionally, the method comprises arranging the image sensing device to provide image data to a processing means configured to process the image data to detect vehicles and road signs in the field of view of the camera assembly.

Optionally, the processing means is configured to process the image data to provide corrected image data in dependence on radial distortion produced by the lens and in dependence on said offset.

Optionally, the method comprises locating the image sensing device and lens within a vehicle having a windscreen and a bonnet positioned in front of the windscreen, so that the lens projects an image onto the sensing surface of a view out through the windscreen and the offset enables at least 90% of the image to be free from an image of the bonnet.

According to yet another aspect of the invention there is provided a method of analyzing data received from a camera of a vehicle, the method comprising: receiving image data from a camera having a lens and an image sensing device; processing the image data to provide corrected image data in dependence on radial distortion produced by the lens and in dependence on an offset of the lens with respect to the image sensing device; processing the corrected image data to detect vehicle and/or road signs in the field of view of the camera; and providing an output signal, the output signal being dependent on position of a detected vehicle and/or dependent on information provided by a detected road sign.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a vehicle including a system embodying the present invention;

FIG. 2 shows the vehicle 100 of FIG. 1 behind a second vehicle;

FIG. 3 shows a partial cross-section through the camera and the windscreen of the vehicle of FIG. 1;

FIG. 4 shows a view of the image sensing device of the camera along the optical axis of its lens;

FIG. 5 shows a partial cross-sectional plan view of the camera;

FIG. 6 shows a schematic diagram of a processing means of the system shown in FIG. 1;

FIG. 7 shows a flowchart illustrating a method performed by the processing means; and

FIG. 8 shows a flowchart illustrating a method of assembling components of a camera for a vehicle.

### DETAILED DESCRIPTION

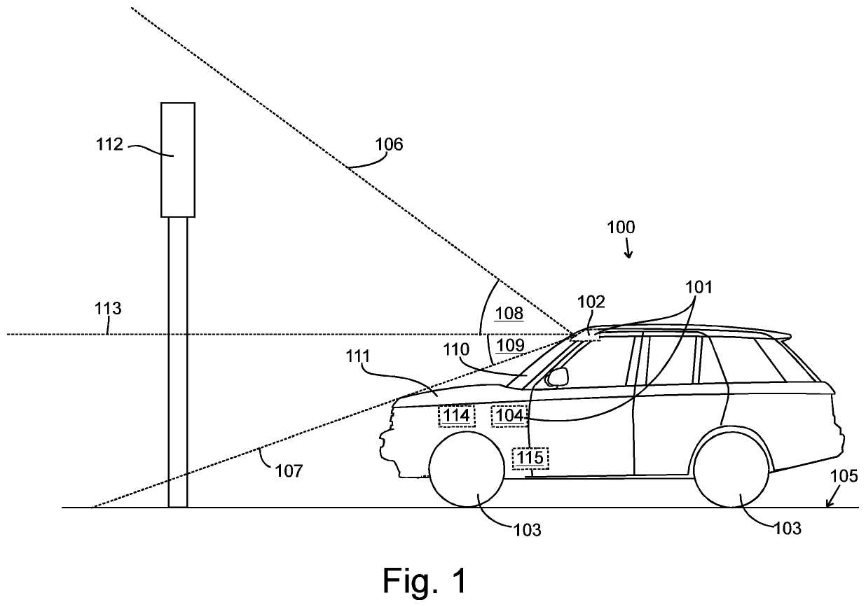

A camera assembly 302, a system 101, a vehicle 100 and a method 800 in accordance with an embodiment of the present invention is described herein with reference to the accompanying FIGS. 1 to 8.

With reference to FIG. 1, the vehicle 100 is a road vehicle comprising roads wheels 103, and in the present embodiment the vehicle 100 is a car. The vehicle 100 also includes a system 101, which comprises a camera 102 and a processing means 104. The system 101 may be, or form a part of, an advanced driver-assistance system (ADAS) configured to control the speed of the vehicle 100 in dependence on signals produced by various sensing devices including the camera 102.

The camera 102 is configured to capture images and produce image data that may be processed in order to identify objects within the captured images. In the present embodiment, the image processing is performed by the processing means 104. It should be noted that, although the processing means 104 is illustrated as being separate from the camera 102, the processing means 104 and the camera 102 may form a single unit, or the processing means 104 may comprise several processing components, one or more of which may be located at the camera 102 and one or more of which may be located separated from the camera 102.

The vehicle 100 has a windscreen 110 and a bonnet 111 extending forward from the lower end of the windscreen 110. The camera 102 is mounted within the vehicle 100 behind the windscreen 110, and the camera 102 has been configured so that its field of view extends down to the bonnet 111 but none of the bonnet 111 is within the field of view of the camera 102. Consequently none of the image data generated by the camera 102 represents an image of the bonnet 111.

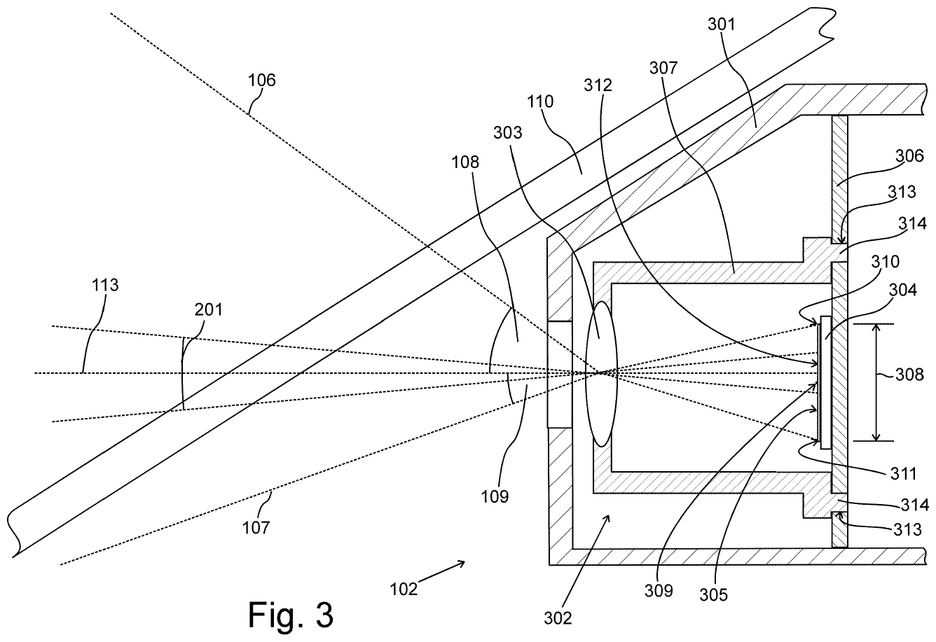

The camera 102 comprises a wide angle lens (303 shown in FIG. 3) providing the camera 102 with a field of view of about 90 degrees in a horizontal plane and about 60 degrees in a vertical plane. However, in alternative embodiments the camera 102 may have a different aspect ratio. For example, in one embodiment the camera 102 has a field of view of about 120 degrees in the horizontal plane and about 60 degrees in the vertical plane.

As illustrated in FIG. 1, the camera 102 is mounted to the vehicle 100 so that, with the vehicle 100 on a horizontal road surface 105, the field of view of the camera 102 is arranged to extend between an upper direction 106, upwards from the camera 102, and a lower direction 107, downwards from the camera 102. The upper direction 106 extends at a first angle 108 above horizontal and the lower direction 107 extends at a second angle 109 below horizontal that is smaller than the first angle 108. The relatively large first angle 108 enables the camera 102 to capture images of road signs (such as the road sign 112) even when the vehicle 100 is close to the road signs.

Although the camera 102 is oriented so that the major part of its field of view is above the horizontal, the camera 102 is configured so that an optical axis 113 of the lens of the camera 102 is substantially horizontal (i.e. within 3 degrees of horizontal). This provides the best resolution in the straight ahead direction to simulate the foveal patch of a human eye.

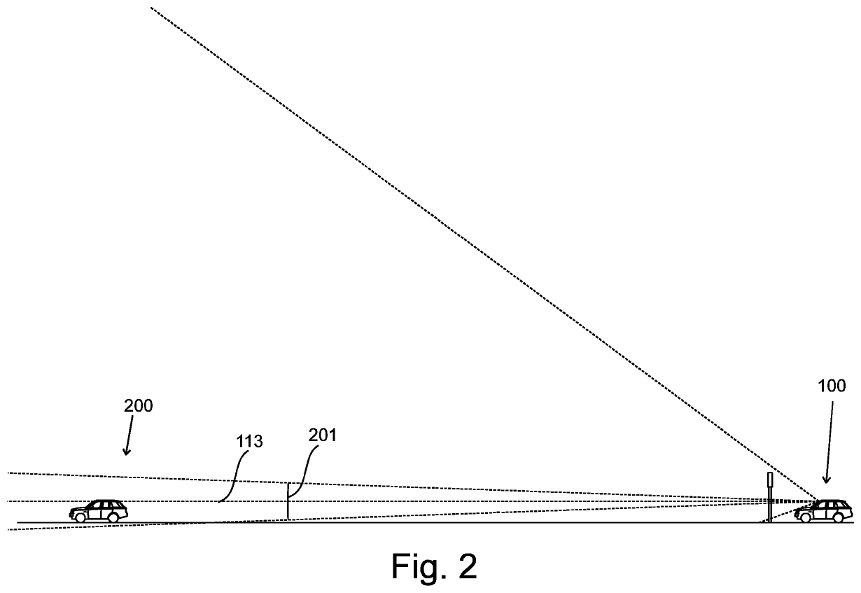

The vehicle 100 is shown in FIG. 2 behind a second vehicle 200. The camera 102 is configured such that its optical resolution in a primary region 201 containing the optical axis 113 is relatively high compared to its optical resolution in regions around the periphery of its field of view. As will be explained below, the optical resolution in the primary region 201 has been arranged to be increased at the expense of reduced optical resolution around the periphery of the field of view. Consequently, the camera 102 is able to provide image data that enables identification of objects appearing in the primary region 201 at a greater distance than could be done otherwise.

A partial cross-section through the camera 102 and the windscreen 110 of the vehicle 100 is shown in FIG. 3. The camera 102 comprises a housing 301 and a camera assembly 302 located within the housing 301. The camera assembly 302 comprises a lens 303 and an image sensing device 304, which has a sensing surface 305. The image sensing device 304 is fixed to a supporting structure 306, which, in the present embodiment, is in the form of a printed circuit board (PCB) 306, and the lens 303 is mounted on the same PCB 306 by a lens support 307. The lens 303 is mounted so that a focal plane of the lens 303 is located at the sensing surface 305 of the image sensing device 304, and its optical axis 113 extends perpendicular to the sensing surface 305. Therefore, when the optical axis 113 is horizontally oriented, the sensing surface 305 extends in a vertical plane.

The sensing surface 305 of the image sensing device 304 has an upper edge 310 and a lower edge 311, which extend into the page in the view of FIG. 3. The sensing surface 305 has a height 308 from its lower edge 311 to its upper edge 310, a width (extending into the page in the view of FIG. 3) and a centre line 309 (extending into the page in the view of FIG. 3). The centre line 309 extends across the width of the sensing surface 305 halfway between its upper edge 310 and lower edge 311.

The centre line 309 is offset from the optical axis 113 of the lens 303, so that the optical axis 113 intercepts the imaging surface 305 above the centre line 309. Consequently, because a greater proportion of the height 308 of the sensing surface 305 is positioned below the optical axis 113 than is positioned above it, a greater proportion of the field of view is above the optical axis 113 than below it. Therefore the first angle 108 between the upper direction 106 and the optical axis 113 of the lens 303 is larger than the second angle 109 between the lower direction 107 and the optical axis 113.

In the present embodiment, the offset of the optical axis 113 of the lens 303 from the centre line 309 of the sensing surface 305 prevents any of the image that is projected onto the sensing surface 305 from containing an image of the bonnet 111. However, in alternative embodiments a small portion of the image that is projected onto the sensing surface 305 represents a view of the bonnet 111, but the offset enables most of the image to be free from an image of the bonnet. It is envisaged that the portion of the image that is free from an image of the bonnet will depend upon the model of the vehicle. However, in some vehicles embodying the present invention, at least 90% of the image is free from an image of the bonnet, while in other embodiments only 85% of the image is free from an image of the bonnet.

In the present embodiment the centre line 309 is offset from the optical axis 113 by a distance that is about 10% of the height of the sensing surface. In other embodiments the centre line 309 is offset from the optical axis 113 by other distances, and in some embodiments the distance is more than 10% of the height of the sensing surface.

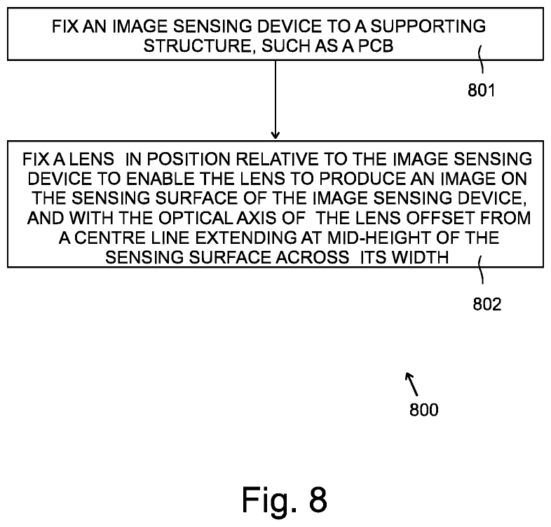

A method 800 of assembling components of a camera 102 for a vehicle 100 is illustrated by the flowchart shown in FIG. 8. At block 801, the method 800 comprises fixing the image sensing device 304 to a supporting structure, such as a PCB 306. For example, the image sensing device 304 may comprise a CCD (charge-coupled device) or a CMOS (complementary metal-oxide semiconductor) image sensor, which may be configured for attachment to a PCB 306 using known techniques.

At block 802 of the method 800, a lens 303 is fixed in position relative to the image sensing device 304 to enable the lens 303 to produce an image on the sensing surface 305. The lens 303 is positioned with its optical axis 113 perpendicular to the sensing surface 305 of the image sensing device 304. For example, the lens 303 may be positioned so that the sensing surface 305 is in the focal plane of the lens 303 to enable images of distant objects to be focused on the sensing surface 305. The lens 303 is fixed in position with its optical axis 113 offset from a centre line 309 that extends at mid-height (i.e. halfway between an upper edge 310 and a lower edge 311) of the sensing surface 305 across its width. For example the lens 303 may be supported within a lens support 307 that is configured to be attached to the PCB 306.

The required positioning of the lens 303 relative to the sensing surface 305 of the image sensing device 304 may be achieved by providing the PCB 306 with features 313, such as holes (shown in FIG. 3), configured to engage features 314 of the lens support 307 when it is correctly positioned.

In an alternative method of assembling components of a camera 102 for a vehicle 100, the camera lens 303 is fixed to a module comprising the image sensing device 302, and the module with the camera lens 303 attached are then connected to a support structure 306, such as a PCB.

In the embodiment of FIG. 3, the lens 303 is a wide angle lens that projects an image onto the sensing surface with barrel distortion, so that the image is stretched in the vicinity of the optical axis 113. The degree to which the image is stretched reduces with distance from the optical axis so that the image is squashed at locations that are distant from the optical axis 113. Thus, as illustrated in FIG. 3, the primary region 201 of the field of view is projected onto a disproportionately large area 312 of the sensing surface 305.

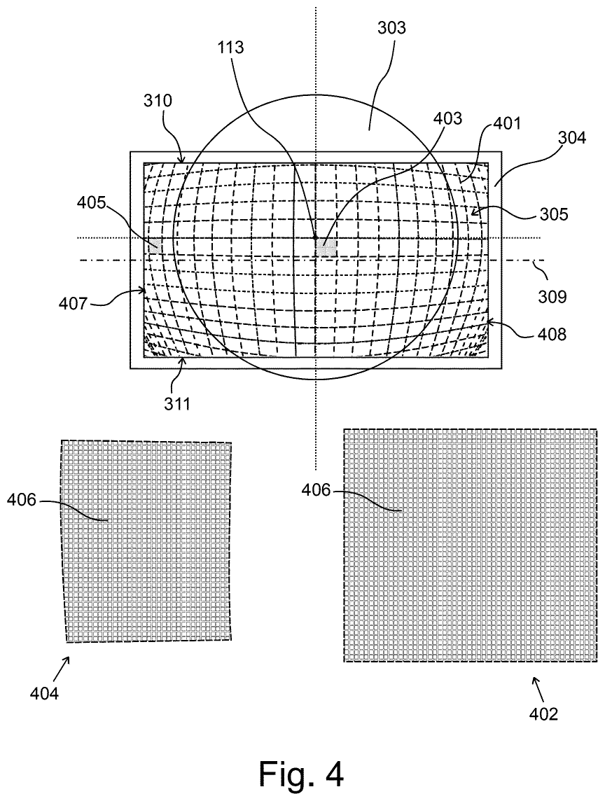

The effect of the radial distortion created by the lens 303 is illustrated in FIG. 4 which shows a view of the image sensing device 304 along the optical axis 113 of the lens 303. As shown in FIG. 4, the sensing surface 305 of the image sensing device 304 is rectangular with upper and lower edges 310 and 311 and side edges 407 and 408.

To illustrate the image distortion, an image of a square grid 401 produced by the lens 303 is shown on the sensing surface 305 of the image sensing device 304. FIG. 4 also shows an enlarged view 402 of a first square 403 of the grid 401 that is adjacent to the optical axis 113, and an enlarged view 404 of a second square 405 of the grid 401 that is remote from the optical axis 113, and near to the side edge 407 of the sensing surface 305.

The barrel distortion of the lens 303 produces image magnification that decreases with distance from the optical axis 113, so that the squares of the grid 401 at the middle of the image, near the optical axis 113, are relatively large when compared to those near the periphery of the image. The sensing surface 305 comprises a two-dimensional array of sensing elements 406, which are illustrated within the enlarged view 402 of the first square 403 and the enlarged view 404 of the second square 405. The sensing elements 406 are equally dimensioned across the whole of the sensing surface 305 and consequently the image of the first square 403 is sensed by many more sensing elements than the image of the second square 405.

It will be appreciated that, as in other cameras, the image sensing device 304 comprises over a million sensing elements 406, and therefore the sensing elements 406 are not shown to scale in FIG. 4. For example, in one embodiment, the image sensing device 304 comprises a camera with about 7 million pixels. Also, the size of the sensing elements 406 may vary in size from one embodiment to another. However, at the optical axis 113, the lens 303 is configured to project 1 degree of the view from the lens 303 over a first number of the sensing elements 406 and to project 1 degree of the view over a smaller second number of the sensing elements 406 adjacent to the edge 407 of the sensing surface 305. In the present embodiment, the first number is 1.5 times the second number, but in other embodiments, the first number may be between 1 and 1.5 times the second number, or it may be even more than 1.5 times the second number.

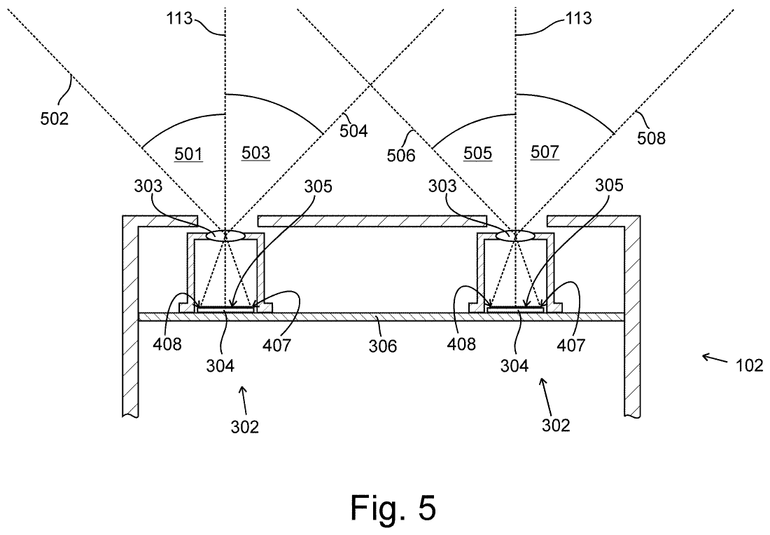

A partial cross-sectional plan view of the camera 102 is shown in FIG. 5. In the present embodiment, the camera 102 is a stereoscopic camera and therefore comprises two camera assemblies 302 as described above. In the present embodiment, the image sensing devices 304 and the lenses 303 of the two camera assemblies 302 are mounted onto a single support structure 306 in the form of the PCB 306.

Each of the camera assemblies 302 has a lens 303 with an optical axis 113 oriented parallel to that of the other lens 303. In the present embodiment, the lens 303 of each camera assembly 102 is positioned relative to its corresponding image sensing device 304 so that the optical axis 113 intercepts the sensing surface 305 of the image sensing device 304 mid-way between the two side edges 407 and 408 of the sensing surface 305. Thus, the field of view of each camera assembly 302 is symmetrically disposed about a vertical plane (into the page as viewed in FIG. 5) containing the corresponding optical axis 113. For example, for the left camera assembly 302, the angle 501 between the optical axis 113 and a leftmost extreme direction 502 of its field of view is equal to the angle 503 between the optical axis 113 and a rightmost extreme direction 504 of its field of view. Similarly, for the right camera assembly 302, the angle 505 between the optical axis 113 and a leftmost extreme direction 506 of its field of view is equal to the angle 507 between the optical axis 113 and a rightmost field of view 508.

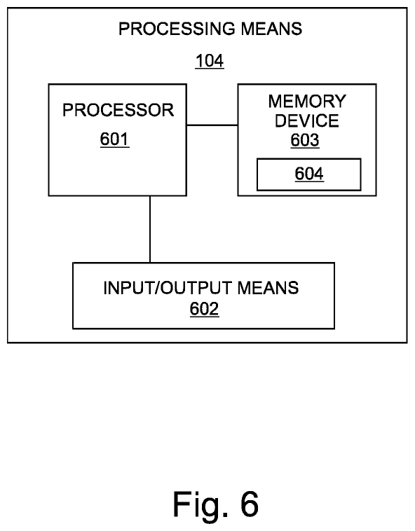

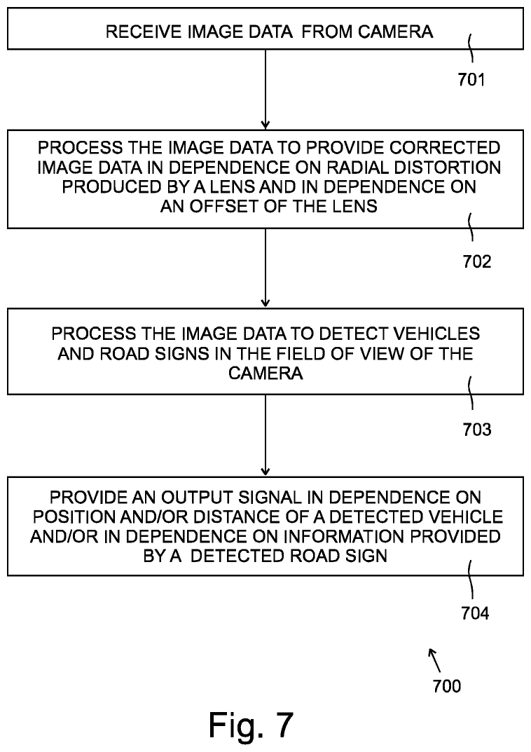

The processing means 104 is shown schematically in FIG. 6, and a method 700 performable by the processing means 104 is illustrated in the flowchart of FIG. 7. With regard to FIG. 6, the processing means 104 comprises at least one electronic processor 601 and an input/output means 602 electrically coupled to the processing means 601 for receiving signals to, and outputting signals from, the at least one processor 601. The processor 601 is configured to receive signals from the camera 102 and providing output signals in dependence on the received input signals. The input/output means 604 may comprise a transceiver to enable communication over a data bus of the vehicle 100.

The processing means 104 also comprises at least one electronic memory device 602 in which instructions 604 are stored. The processor 601 is electrically coupled to the at least one memory device 602, and the processor 601 is configured to access the instructions 604 stored in the memory device 603 and execute the instructions to perform the method 700 illustrated in FIG. 7.

As illustrated in FIG. 7, the method 700 performable by the processing means 104 comprises receiving image data from the camera 102 at block 701. Because the image data is indicative of an image that is radially distorted, as described above with reference to FIGS. 3 and 4, at block 702 the processing means 104 is configured to process the image data to provide corrected image data. The processing at block 702 is performed in dependence on the radial distortion produced by the lens 303 and in dependence on the positional offset of the lens 303 relative to the sensing surface 305 of the image sensing device 304. The distortion produced by the lens 303 effectively causes a transformation of the scene that is being imaged and, as is known in the art, the processing means 104 effectively provides an inverse transformation to generate the corrected image data representing a corrected image.

The corrected image data may then be processed at block 703 to detect images of vehicle and road signs in the field of view of the camera 102.

At block 704 of the method 700, an output signal is provided in dependence on at least one of: a position of a detected vehicle; a distance to a detected vehicle; and information provided by a detected road sign. In an embodiment in which the system 101 forms a part of an ADAS system, the processing means 104 may be configured to provide an output signal indicating that a detected object is a vehicle as well as the position and velocity of the detected vehicle, and if a detected object is recognised to be a road sign, the processing means 104 may be configured to provide an output signal indicative of the information provided by the road sign. Alternatively, in some embodiments, the processing means 104 may be configured to provide the processing required to provide at least one function of an ADAS system, such as autonomous cruise control or autonomous emergency braking. In such an embodiment, the processing means 104 may be configured to receive input signals from several different sensors, including the camera 102, and provide output signals to a powertrain control module (114 shown in FIG. 1) and/or a braking system (115 shown in FIG. 1) of the vehicle 100 to cause its speed to be controlled in dependence on the received signals.

For purposes of this disclosure, it is to be understood that the processing means described herein may comprise an electronic control unit or computational device having one or more electronic processors. A vehicle and/or a system thereof may comprise a single control unit or alternatively different functions of the processing means may be embodied in, or hosted in, different control units or controllers. A set of instructions could be provided which, when executed, cause the controller(s) or control unit(s) to implement the control techniques described herein (including the described method(s)). The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on or more electronic processors, optionally the same one or more processors as the first controller. It will be appreciated, however, that other arrangements are also useful, and therefore, the present disclosure is not intended to be limited to any particular arrangement. In any event, the set of instructions described above may be embedded in a computer-readable storage medium (e.g., a non-transitory computer-readable storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

It will be appreciated that various changes and modifications can be made to the present invention without departing from the scope of the present application.

The blocks illustrated in the FIG. 7 may represent steps in a method and/or sections of code in the computer program 604, and it may be possible for some steps to be omitted. Furthermore, the illustration of a particular order to the blocks in FIGS. 7 and 8 does not necessarily imply that there is a required or preferred order for the blocks and the order and arrangement of the blocks may be varied.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A vehicle having a windscreen and a bonnet positioned in front of the windscreen, the vehicle comprising a camera assembly, the camera assembly comprising:
an image sensing device comprising a sensing surface having a width, a height and a centre line extending laterally across the width, the image sensing device being configured to generate image data indicative of an image received at the sensing surface; and
a lens having an optical axis, and positioned to produce an image on the sensing surface, the lens being positioned to project an image onto the sensing surface of a view out through the windscreen;
wherein the optical axis of the lens is offset from the centre line of the sensing surface.

2. A vehicle according to claim 1, wherein the lens is configured to provide image magnification that decreases with distance from the optical axis.

3. A vehicle according to claim 1, wherein:
the image sensing device comprises a two-dimensional array of sensing elements;
at the optical axis, the lens is configured to project 1 degree of the view from the lens over a first number of the sensing elements;
the lens is configured to project 1 degree of the view from the lens over a second number of the sensing elements adjacent to an edge of the sensing surface; and
the first number is at least 1.5 times the second number.

4. A vehicle according to claim 1, wherein the optical axis of the lens is offset from the centre line of the sensing surface by a distance of more than one tenth of the height of the sensing surface.

5. A vehicle according to claim 1, wherein the camera assembly comprises a printed circuit board on which the image sensing device and the lens are mounted.

6. A vehicle according to claim 1, wherein the sensing surface is arranged in a vertical plane and the optical axis of the lens is vertically offset from the centre line of the sensing surface.

7. A vehicle according to claim 6, wherein the sensing surface defines a vertical field of view of the camera assembly that extends between an upper direction and a lower direction, wherein a first angle between the upper direction and the optical axis of the lens is larger than a second angle between the lower direction and the optical axis.

8. A vehicle according to claim 1, wherein the camera assembly and a similarly configured camera assembly form parts of a stereoscopic camera.

9. A vehicle according to claim 1, comprising a system comprising the camera assembly and a processing means configured to process the image data to detect vehicles and/or road signs in the field of view of the camera assembly.

10. A vehicle according to claim 9, wherein the processing means is configured to process the image data to provide corrected image data in dependence on radial distortion produced by the lens and in dependence on said offset.

11. A vehicle according to claim 1, wherein the offset enables at least 90% of the image to be free from an image of the bonnet.

12-13. (canceled)
